(19) United States
(12) Patent Application Publication
(10) Pub. No.: US 2026/0094996 A1
(43) Pub. Date: Apr. 2, 2026

(54) LEVER-TYPE CONNECTOR AND CONNECTOR ASSEMBLY

(71) Applicant: SUMITOMO WIRING SYSTEMS, LTD., Mie (JP)

(72) Inventors: Sho KOBAYASHI, Mie (JP); Yoichi TAKAGI, Mie (JP); Toshihiro ITO, Mie (JP); Tsuyoshi MASE, Mie (JP); Takahiro KIKUCHI, Mie (JP); Toya TAICHI, Mie (JP)

(21) Appl. No.: 19/335,974

(22) Filed: Sep. 22, 2025

(30) Foreign Application Priority Data
Sep. 30, 2024 (JP) 2024-170123

(51) Int. Cl. H01R 13/629

(52) U.S. Cl. CPC H01R 13/6295

(57) ABSTRACT

A housing of a lever-type connector includes a lock arm that extends in a cantilever manner and that is capable of warping toward a detection terminal, a lever includes a lever-side pressing part that warps the lock arm toward the detection terminal during a process of rotation from an engagement start position to an engagement completion position, and the lock arm includes a pressing portion including a protruding part that presses the detection terminal through warping and separates the detection terminal away from a counterpart detection terminal, and a low-rigidity portion that is positioned closer to a proximal end side of lock arm than the pressing portion and that has a lower rigidity than the pressing portion.

### CROSS-REFERENCE TO RELATED APPLICATIONS

This application is based on and claims priority from Japanese Patent Application No. 2024-170123, filed on Sep. 30, 2024, with the Japan Patent Office, the disclosure of which is incorporated herein in its entirety by reference.

### TECHNICAL FIELD The present disclosure relates to a lever-type connector and to a connector assembly.

### BACKGROUND

As a lever-type connector, a lever-type connector described in Japanese Patent Laid-Open No. 2007-173164 (hereinafter “Patent Document 1”) is conventionally known. The lever-type connector described in Patent Document 1 includes a housing, a lever that is rotatably attached to the housing, and a detection terminal held inside the housing. In the process of rotation of the lever from an engagement start position to an engagement completion position, the lever warps a warping piece of the housing, and thus presses the detection terminal by the warping piece to a position where the detection terminal does not contact a counterpart detection terminal of a counterpart connector. When the lever reaches the engagement completion position, pressing on the warping piece is released, and the detection terminal is caused to contact the counterpart detection terminal. In this manner, the lever-type connector is capable of maintaining the detection terminal in a state where the detection terminal is separated from the counterpart detection terminal until engagement of the connectors is completed.

The warping piece may sometimes fail to press the detection terminal by an intended amount according to rotation of the lever. In such a case, the connectors may proceed to engage with each other while the detection terminal and the counterpart detection terminal are in contact with each other, and the detection terminal and the counterpart detection terminal may fail to form a detection circuit due to wear or deformation of the detection terminal.

### SUMMARY

It is an object to allow improving operability of a connection operation of a lever-type connector with a counterpart connector.

This object is solved according to the invention by the features of the independent claims. Particular embodiments of the invention are subject of the dependent claims.

According to one aspect, there is provided a lever-type connector capable of being engaged with a counterpart connector including at least one counterpart detection terminal, the lever-type connector comprising: a housing; a lever that is attached to the housing in a manner capable of displacement between an engagement start position and an engagement completion position; and at least one detection terminal that is held inside the housing, and that forms a detection circuit by coming into contact with the counterpart detection terminal, wherein the housing includes at least one warping piece that substantially extends in a cantilever manner and that is capable of warping toward the detection terminal, wherein the lever includes at least one lever-side pressing part that applies a pressing force for warping the warping piece toward the detection terminal during a process of displacement from the engagement start position to the engagement completion position, and wherein the warping piece includes at least one pressing portion including at least one protruding part that presses the detection terminal and separates the detection terminal away from the counterpart detection terminal, and a low-rigidity portion that is positioned closer to a proximal end side of the warping piece than the pressing portion, and that has a lower rigidity than the pressing portion.

According to a particular embodiment, there is provided a lever-type connector capable of being engaged with a counterpart connector including a counterpart detection terminal, the lever-type connector including a housing, a lever that is attached to the housing in a manner capable of rotating or pivoting between an engagement start position and an engagement completion position, and a detection terminal that is held inside the housing, and that forms a detection circuit by coming into contact with the counterpart detection terminal, where the housing includes a warping piece that extends in a cantilever manner and that is capable of warping toward the detection terminal, the lever includes a lever-side pressing part that applies a pressing force for warping the warping piece toward the detection terminal during a process of rotation or pivotal movement from the engagement start position to the engagement completion position, and the warping piece includes a pressing portion including a protruding part that presses the detection terminal and separates the detection terminal away from the counterpart detection terminal, and a low-rigidity portion that is positioned closer to a proximal end side of the warping piece than the pressing portion, and that has a lower rigidity than the pressing portion.

Accordingly, when the lever is displaced (particularly rotated or pivoted) from the engagement start position toward the engagement completion position, the warping piece of the housing is warped toward the detection terminal due to a pressing force from the lever-side pressing part. Because the warping piece includes the low-rigidity portion with a low rigidity on the proximal end side relative to the pressing portion, a start point of warping of the warping piece is close to the proximal end, and thus, an amount of displacement of the pressing portion in a pressing direction can be secured. Accordingly, at the time of engagement of the lever-type connector with the counterpart connector, the detection terminal and the counterpart detection terminal can be appropriately separated by the warping piece, and wear and deformation of the detection terminal can be prevented. Thus, overall operability of the connection process is improved.

Particularly, the warping piece is made of resin.

Further particularly, the pressing portion includes at least one rib that substantially extends in an extending direction of the warping piece.

Accordingly, a rigidity of the pressing portion is higher than that of the low-rigidity portion thanks to the rib(s) extending in the extending direction of the warping piece.

Furthermore, when the rigidity particularly is made different between the portions of the warping piece by the rib(s), appearance defects such as sink marks can be reduced compared to a case where the difference is due to a difference in thicknesses.

Further particularly, the housing includes a cover member that is provided at or near a front end that engages with the counterpart connector.

Further particularly, the warping piece substantially extends rearward from a front end side of the housing, and the low-rigidity portion at least partly is covered by the cover member.

Accordingly, the low-rigidity portion at least partly is covered by the cover member and is thus prevented from being damaged due to impact from outside.

Further particularly, the warping piece is made of resin.

Further particularly, the pressing portion includes at least one rib that substantially extends in an extending direction of the warping piece, and an end of the rib close to the low-rigidity portion is chamfered.

Accordingly, because the end of the rib(s) close to the low-rigidity portion particularly is chamfered, the rib(s) does/do not easily interfere with the cover member or a housing of the counterpart connector when the warping piece warps due to a pressing force from the lever, and the warping piece is prevented from not being able to easily warp with the low-rigidity portion side as the start point.

Further particularly, the warping piece includes, at a part closer to a distal end than the pressing portion, at least one pressed portion for receiving a pressing force from the lever-side pressing part.

Further particularly, the rib(s) join(s) the pressing portion and the pressed portion.

Accordingly, the warping piece may be prevented from being bent on the pressed portion side due to a pressing force applied by the lever, and the pressing force from the lever can be easily transmitted to the low-rigidity portion side.

Accordingly, the warping piece can be easily warped with the low-rigidity portion side as the start point.

Further particularly, wherein when the lock arm warps, the protruding part presses the detection terminal, and the detection terminal can be resiliently deformed.

According to another aspect, three is provided a connector assembly comprising a lever-type connector according to the above aspect or a particular embodiment thereof and a counterpart connector engageable therewith.

According to the above, a lever-type connector and a respective connector assembly that can improve overall operability, particularly by suppressing wear and deformation of a detection terminal at a time of engaging with a counterpart connector, can be provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a lever-type connector according to an embodiment.

FIG. 2 is a plan view of the lever-type connector.

FIG. 3 is a cross-sectional view taken along A-A in FIG. 2.

FIG. 4 is a perspective view of a lever.

FIG. 5 is a diagram showing, in the cross-sectional view taken along A-A in FIG. 2, a state where the lever is at an engagement start position.

FIG. 6 is a diagram showing, in the cross-sectional view taken along A-A in FIG. 2, a state where the lever is beginning to press a lock arm.

FIG. 7 is a diagram showing, in a cross-sectional view taken along B-B in FIG. 2, a state where the lever is pressing the lock arm.

FIG. 8 is a diagram describing warping of the lock arm.

FIG. 9 is a diagram showing, in the cross-sectional view taken along A-A in FIG. 2, a state where the lever is at an engagement completion position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Furthermore, the term “facing” in the present specification refers to a case where surfaces or members are at positions in front of each other, and includes not only a case where the surfaces or members are at positions completely in front of each other, but also a case where the surfaces or members are at positions partially in front of each other. Also, the term “facing” in this specification includes both a case where a member different from two portions is interposed between the two portions, and a case where nothing is interposed between the two portions.

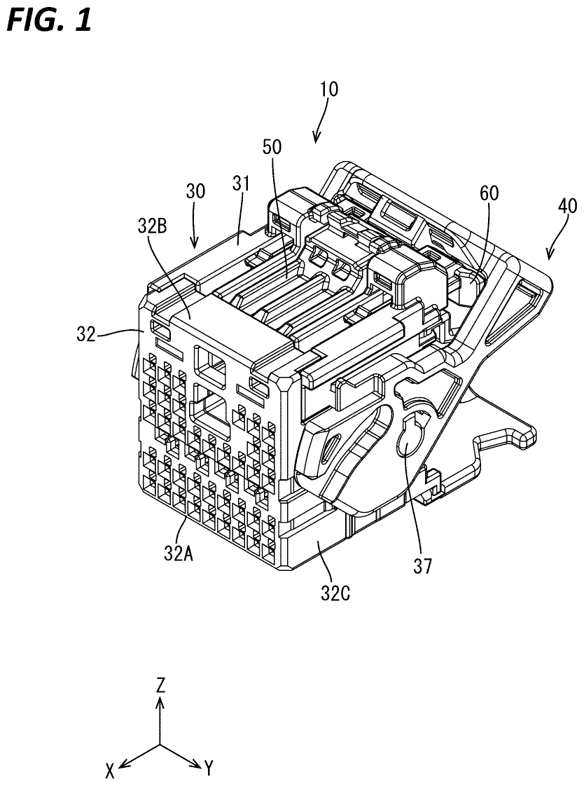

The embodiment of the present disclosure will be described with reference to FIGS. 1 to 9. In the following description, an arrow Z points to an upper side, an arrow X points to a front side, and an arrow Y points to a left side. Additionally, with respect to a plurality of same or similar members, one or some of the members may be denoted by a reference sign while omitting the reference sign for the rest of the members.

A lever-type connector 10 is a connector that is capable of being engaged with a counterpart connector 80.

As shown in FIG. 1, the lever-type connector 10 mainly includes a housing 30, a lever 40, and a detection member 60.

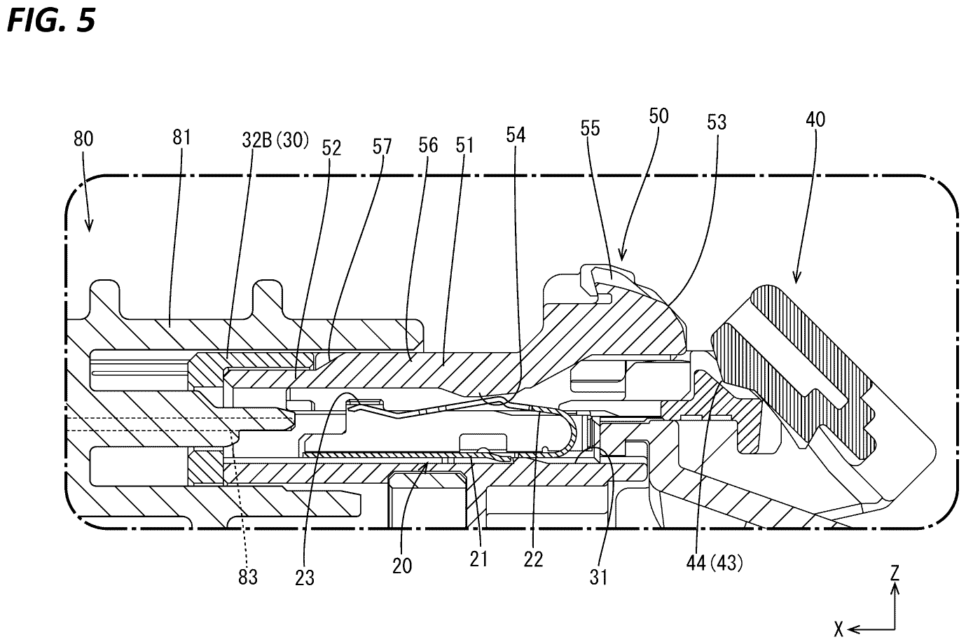

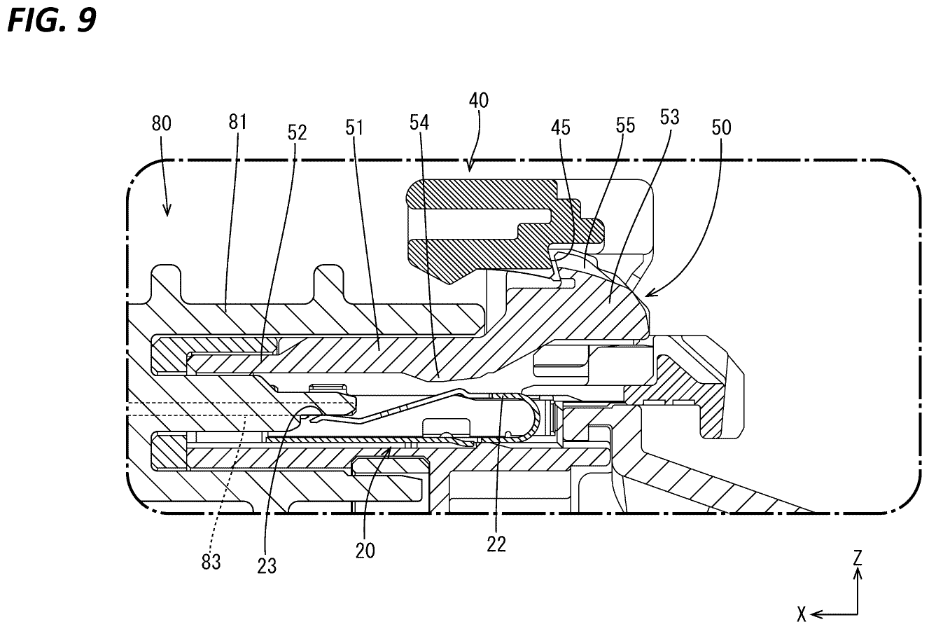

The lever 40 is to be attached to the housing 30 in a manner capable of being displaceable (particularly rotating or pivoting) between an engagement start position shown in FIG. 5 and an engagement completion position shown in FIG. 9.

As shown in FIG. 5, the counterpart connector 80 includes a counterpart housing 81 that is capable of being engaged with the housing 30. Although not shown, the counterpart housing 81 includes, on inside, one or more cam pins that protrude from inner side surface(s) particularly on left and right.

### Housing

The housing 30 e.g. is made of insulating synthetic resin.

The housing 30 particularly includes a housing main body 31 and a cover member 32, as shown in FIG. 1.

Specifically, the housing main body 31 has a substantially cuboid shape.

A rotation shaft 37 that rotatably or pivotably supports the lever 40 particularly is provided on one or more lateral sides, particularly on left and right side surfaces, of the housing main body 31.

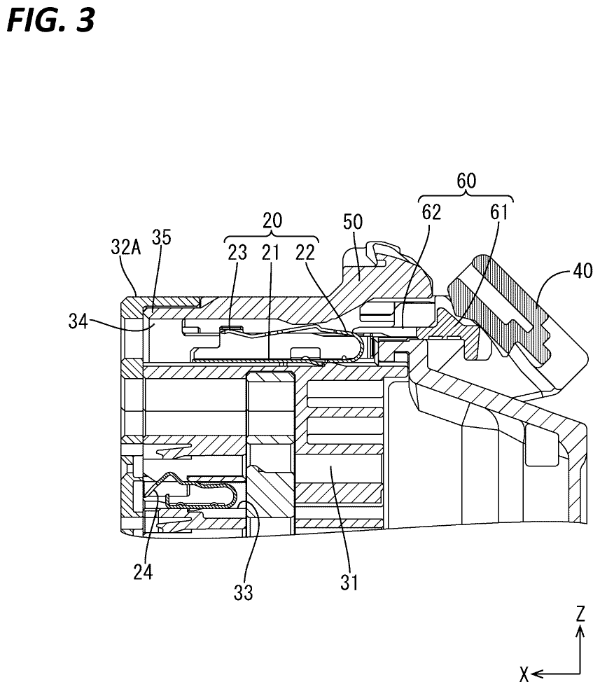

As shown in FIG. 3, the housing main body 31 particularly includes a first terminal accommodating section 33 for accommodating at least one terminal 24, and/or a second terminal accommodating section 34 for accommodating at least one detection terminal 20 described later.

Each accommodating section 33, 34 particularly is a space that penetrates the housing main body 31 in a front-back direction.

The second terminal accommodating section 34 particularly is provided inside the housing main body 31, at a part adjacent to (e.g. above) the first terminal accommodating section 33 and/or at an intermediate position (particularly substantially a center) in a left-right direction.

The at least one terminal 24 that at least partly is accommodated in the first terminal accommodating section 33 is made of conductive material such as metal, and is to be connected to at least one corresponding counterpart terminal of the counterpart connector 80.

At least one electrical wire, not shown, is connected to the at least one respective terminal 24, and the electrical wire is guided out of the housing 30 particularly substantially toward a rear side.

The detection terminal 20 that at least partly is accommodated in the second terminal accommodating section 34 particularly is made of conductive material such as metal.

The detection terminal 20 particularly includes a flat part 21 disposed along (particularly a lower surface of) the second terminal accommodating section 34, at least one spring part 22 bent from the flat part 21, and/or at least one contact part 23 extending from the spring part 22.

Specifically, the detection terminal 20 substantially has a bent shape where the contact part 23 side forms an upward convex shape.

A distal end side of the spring part 22 particularly is split into plural parts, e.g. into two, and a plurality of (particularly a pair of left and right) contact parts 23 are provided.

As shown in FIG. 9, when the lever-type connector 10 is engaged or engageable with the counterpart connector 80, the (particularly each) contact part 23 of the detection terminal 20 contacts at least one contact part of a counterpart detection terminal 83.

The detection terminal 20 and the counterpart detection terminal 83 are or can be thereby electrically connected, and a detection circuit is formed.

As shown in FIG. 1, the cover member 32 particularly is a member to be provided at or near a front end of the housing 30, and/or particularly includes a front cover part 32A, an upper or lateral cover part 32B, and/or one or more side cover parts 32C.

The front cover part 32A particularly is a part of the cover member 32 that at least partly covers a front surface side of the housing main body 31.

One or more, particularly a plurality of openings are formed in the front cover part 32A, at one or more positions corresponding to the one or more accommodating sections 33, 34 of the housing main body 31.

The upper or lateral cover part 32B particularly is a part of the cover member 32 that substantially extends from an upper or lateral side of the front cover part 32A and/or that at least partly covers a front end side of an upper wall of the housing main body 31.

The one or more side cover parts 32C are a part of the cover member 32 that extend from one or more (particularly left and/or right) sides of the front cover part 32A and/or that at least partly cover (particularly front side(s) of) side wall(s) of the housing main body 31.

The housing 30 allows the one or more terminals 20, 24 at least partly accommodated in the one or more accommodating sections 33, 34 to be exposed from the openings in a state where the cover member 32 is attached to (particularly a front end side of) the housing main body 31.

As shown in FIG. 3, the housing main body 31 particularly includes a lock arm 50 that substantially extends rearward from a (particularly upper-wall) front-end part 35 that is a front end of the upper or lateral wall.

The lock arm 50 particularly substantially extends rearward from the upper-wall front-end part 35 in a cantilever manner, and/or is capable of warping in an up-down (or outward-inward) direction relative to the housing main body 31.

In the present embodiment, the lock arm 50 is an example of a warping piece.

A detailed structure of the lock arm 50 will be described later.

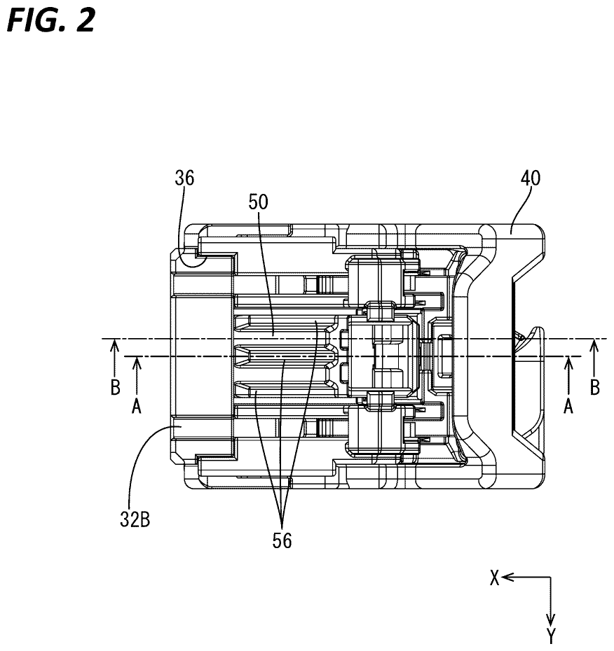

As shown in FIG. 2, on a front side of the upper wall of the housing main body 31, an insertion groove 36 for allowing insertion of the upper cover part 32B of the cover member 32 particularly is formed.

A bottom surface of the insertion groove 36 particularly includes the upper-wall front-end part 35 and/or a part of a proximal end side of the lock arm 50 (a low-rigidity portion 52 described later).

In other words, the upper-wall front-end part 35 and/or the low-rigidity portion 52 included in the bottom surface of the insertion groove 36 particularly are parts that at least partly are covered by the upper cover part 32B of the cover member 32.

### Lever

The lever 40 is made e.g. of insulating synthetic resin.

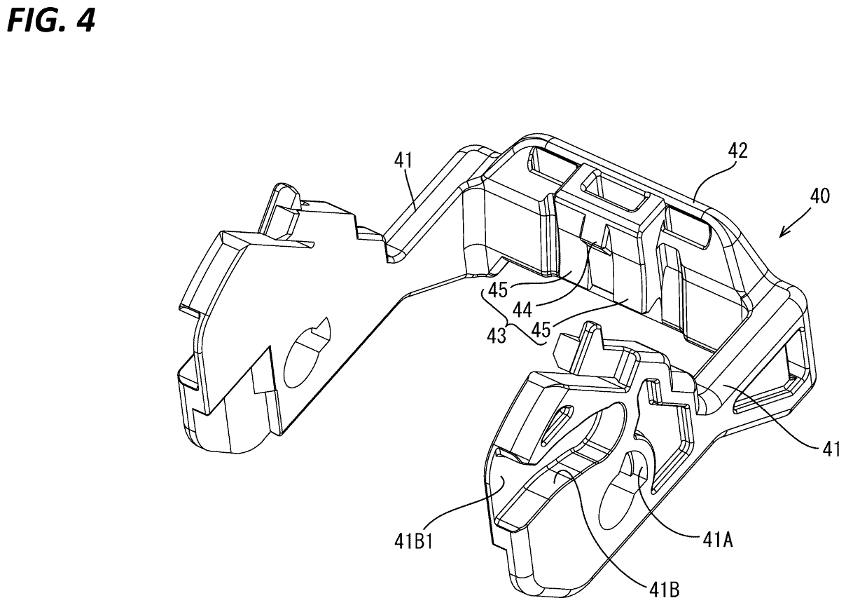

As shown in FIG. 4, the lever 40 particularly is substantially U-shaped as a whole, and/or includes an operation part 42 to be displaced (particularly rotated or pivoted) by an operator, one or more, particularly a pair of (particularly substantially plate-shaped) parts 41 that extend in a same direction from one or both ends of the operation part 42, and/or a lever-side pressing part 43 provided on the operation part 42.

A shaft hole 41A through which the rotation shaft 37 provided on a side wall of the housing main body 31 at least partly passes, and at least one cam groove 41B that is recessed in a left-right direction, namely, a thickness direction of the plate-shaped part 41, from an outer surface of the plate-shaped part 41 particularly are formed in the plate-shaped part 41.

The cam groove 41B particularly includes an entrance opening 41B1 at an outer edge of the plate-shaped part 41, and the cam groove 41B substantially extends in a substantially arc shape from the entrance opening 41B1 toward the shaft hole 41A.

The entrance opening 41B1 particularly is an opening for receiving the cam pin into the cam groove 41B.

The lever-side pressing part 43 protrudes inward from the operation part 42 in direction substantially perpendicular to a displacement direction of the lever 40, particularly in a rotation radial direction of the lever 40.

The rotation radial direction of the lever 40 is a direction that particularly is orthogonal to an extending direction of the rotation shaft 37 (the left-right direction) and/or that particularly is an extending direction of an axis that passes through a center of rotation.

Specifically, a direction toward the rotation shaft 37 is given as inward, and a direction away from the rotation shaft 37 is given as outward.

The lever-side pressing part 43 particularly includes a first pressing part 44 and/or one or more second pressing parts 45 that protrude inward from the operation part 42 in the rotation radial direction.

The first pressing part 44 particularly is disposed at a substantially center of the operation part 42 in the left-right direction.

The second pressing part(s) 45 particularly is/are disposed on the operation part 42, specifically on left and right in a manner sandwiching the first pressing part 44.

As shown in FIG. 3, the detection member 60 that is capable of detecting an engagement state of the lever-type connector 10 and the counterpart connector 80 by receiving a pressing operation particularly is attached on a rear side of the housing 30.

Specifically, the detection member 60 includes a main body part 61, and one or more arm parts 62 that extend forward from (particularly left and/or right ends of) the main body part 61.

The detection member 60 particularly is held in such a state that the arm parts 62 substantially are slidable in the front-back direction relative to the housing main body 31.

When engagement between the lever-type connector 10 and the counterpart connector 80 is complete, the arm part(s) 62 of the detection member 60 particularly is/are slid between the lock arm 50 and the detection terminal 20 due to a pressing operation on the main body part 61, and a detection position can be reached.

By contrast, when engagement between the lever-type connector 10 and the counterpart connector 80 is not complete, the arm part(s) 62 of the detection member 60 particularly cannot be slid, and the detection position cannot be reached.

### Lock Arm

Next, a detailed structure of the lock arm 50 will be described.

As shown in FIG. 5, the lock arm 50 particularly includes a pressing portion 51 provided with at least one protruding part 54 for pressing the detection terminal 20, the low-rigidity portion 52 positioned closer to a proximal end side of the lock arm 50 than the pressing portion 51, and/or a pressed portion 53 provided at a distal end of the lock arm.

Specifically, the pressed portion 53 is a part of the lock arm that receives a pressing force from the lever-side pressing part 43 of the lever 40.

The pressed portion 53 particularly includes at least one engaging lock part 55 that protrudes upward or outward.

In the present embodiment, the pressed portion 53 is provided with one or more, particularly two engaging lock parts 55 that are provided particularly spaced apart in the left-right direction.

The pressing portion 51 particularly includes the protruding part 54 on a lower surface that substantially faces the detection terminal 20, and/or the protruding part 54 protrudes downward or inward from the lower surface.

When the lock arm 50 warps downward or inward, the protruding part 54 particularly presses the detection terminal 20, and the detection terminal 20 can be elastically or resiliently deformed.

The pressing portion 51 particularly includes, on an upper or outer surface, at least one rib 56 that substantially extends in an extending direction of the lock arm 50 (the front-back direction).

As shown in FIG. 2, in the present embodiment, three ribs 56 specifically are provided on the upper surface of the pressing portion 51 while being disposed at substantially regular intervals in the left-right direction.

Because the one or more ribs 56 are provided on the pressing portion 51, rigidity of the pressing portion 51 is increased.

As shown in FIG. 5, an end 56A at a front of the (particularly each) rib 56 particularly extends short of the low-rigidity portion 52, and does not interfere with the upper cover part 32B of the cover member 32.

Furthermore, a chamfered part 57 that is a surface that is inclined at a specified (predetermined or predeterminable) angle particularly is formed at an end on a front side (that is, the low-rigidity portion 52 side) of the (particularly each) rib 56.

Accordingly, even when the lock arm 50 is warped, the end of the rib 56 on the low-rigidity portion 52 side particularly does not interfere with the upper cover part 32B and the counterpart housing 81.

By contrast, an end at a rear of each rib 56 particularly is joined to the pressed portion 53.

Accordingly, as described later, when the pressed portion 53 is pressed by the lever-side pressing part 43 of the lever 40, the pressed portion 53 does not bend downward.

The low-rigidity portion 52 particularly is a part of the lock arm 50 that has a thinner thickness than the pressing portion 51. Here, “a thinner thickness than the pressing portion 51” means that the thickness is thinner than a maximum thickness of the pressing portion 51 including the rib 56.

Additionally, the thickness of the low-rigidity portion 52 may be thicker than the thickness of the pressing portion 51 not including the rib 56.

Because the low-rigidity portion 52 particularly has a thinner thickness than the pressing portion 51, rigidity of the low-rigidity portion 52 is lower than that of the pressing portion 51.

### Engagement Between Lever-Type Connector and Counterpart Connector

In the case of causing the lever-type connector 10 to be engaged with the counterpart connector 80, first, as shown in FIG. 5, specifically the lever-type connector 10 and the counterpart connector 80 are slightly engaged with each other in a state where the lever 40 is at the engagement start position. Then, the cam pin of the counterpart connector 80 enters the cam groove 41B provided on the lever 40, and the cam pin is engaged with the cam groove 41B.

In the case where the lever 40 substantially is at the engagement start position, the lever-side pressing part 43 of the lever 40 particularly is separated from the lock arm 50, and thus, the lock arm 50 and the detection terminal 20 are not deformed and are in a natural state.

Moreover, the detection terminal 20 and the counterpart detection terminal 83 particularly are not in contact with each other.

The operation part 42 of the lever 40 particularly is operated in the state where the cam pin of the counterpart connector 80 is in the cam groove 41B of the lever 40, and the lever 40 is displaced (particularly rotated or pivoted) from the engagement start position toward the engagement completion position.

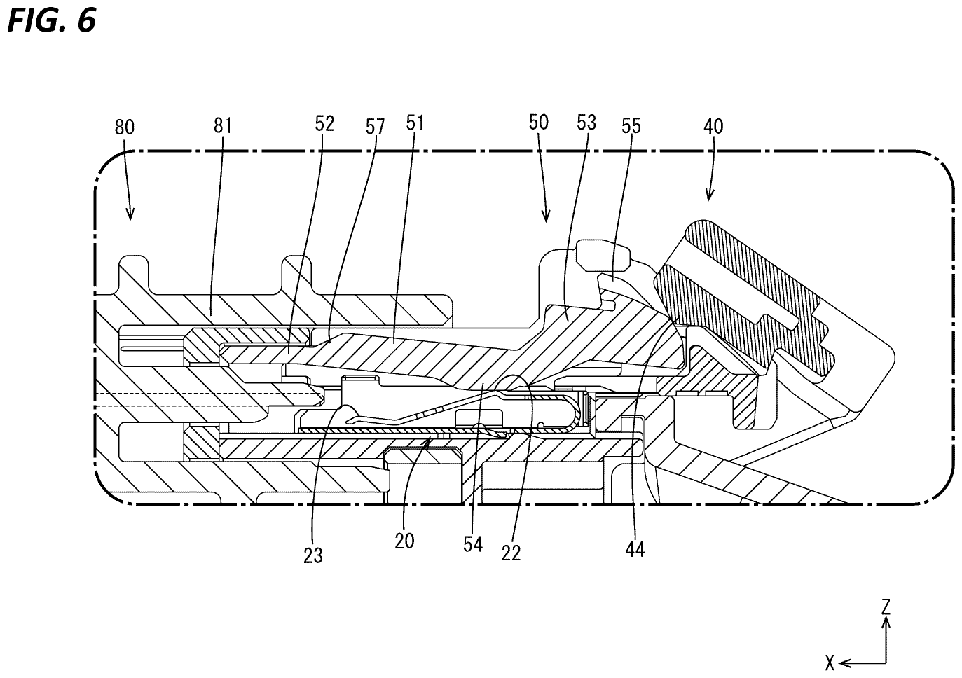

As shown in FIG. 6, as the lever 40 is displaced (particularly rotatedor pivoted), the first pressing part 44 of the lever-side pressing part 43 particularly substantially comes into contact with a distal end of the pressed portion 53.

The lock arm 50, thus, starts to warp by a pressing force from the lever 40. Then, the protruding part 54 of the lock arm 50 particularly is displaced downward or inward to press the detection terminal 20, and the one or more contact parts 23 of the detection terminal 20 are displaced downward or inward.

Furthermore, when the lever 40 is displaced (particularly rotated or pivoted) toward the engagement completion position, the first pressing part 44 at least partly enters an area adjacent to the engaging lock part(s), particularly a gap between the two engaging lock parts 55, while pressing the pressed portion 53.

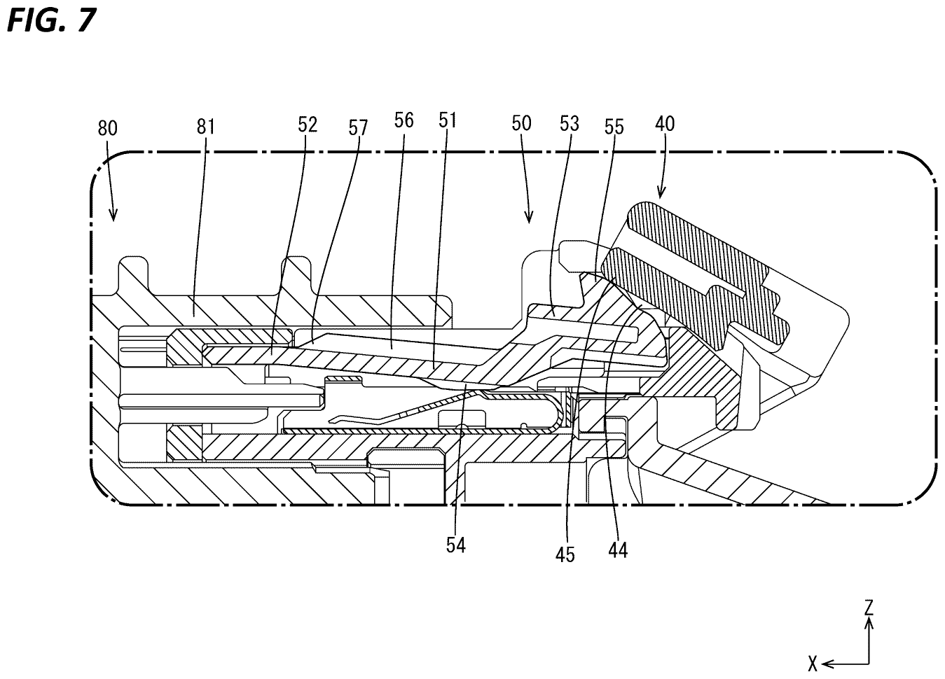

Then, as shown in FIG. 7, the one or more second pressing parts 45 of the lever 40 particularly abut corresponding upper surface(s) of the engaging lock part(s) 55 according to the displacement (particularly rotation or pivotal movement) of the lever 40, and start to press the pressed portion 53.

When the lever 40 is further displaced (particularly rotated or pivoted), the first pressing part 44 particularly separates from the lock arm 50 in a state where the one or more second pressing parts 45 are in contact with the one or more upper surfaces of the one or more engaging lock parts 55.

At this time, the contact part of the counterpart detection terminal 83 particularly is at a position that at least partly overlaps the detection terminal 20 in the front-back direction.

However, the protruding part 54 of the lock arm 50 that is warped particularly presses the detection terminal 20, and causes the contact part 23 to separate from the counterpart detection terminal 83.

Here, if an amount of downward or inward displacement of the protruding part 54 of the lock arm 50 is small, the detection terminal 20 particularly is possibly not sufficiently pressed by the protruding part 54 during the process of engagement between the lever-type connector 10 and the counterpart connector 80.

In such a case, engagement between the connectors particularly proceeds or may proceed in a state where the detection terminal 20 and the counterpart detection terminal 83 are in contact with each other, thus possibly causing wear or deformation of a surface of the detection terminal 20.

For example, when rigidity of the lock arm 50 particularly is uniform in the front-back direction, the lock arm 50 may warp in such a manner as to obstruct a pressing force on the detection terminal 20 due to a change in a direction in which the lever 40 presses the lock arm 50 or a reaction force from the detection terminal 20.

In particular, in the present embodiment, there are a period in which the lock arm 50 is pressed by the first pressing part 44, and a period in which the lock arm 50 is pressed by the second pressing parts 45, and thus, the direction in which the lever 40 presses the lock arm 50 is easily changed.

For example, in the case where the lock arm 50 particularly is warped with a part more on the distal end side than the protruding part 54 as a start point, the amount of downward displacement of the protruding part 54 is small.

Additionally, the amount of downward displacement of the protruding part 54 particularly is an amount of displacement in the up-down (or inward-outward) direction between a distal end of the protruding part 54 of the lock arm 50 in a natural state and the distal end of the protruding part 54 after warping.

Additionally, the distal end of the protruding part 54 particularly is a lower side end of the protruding part 54 that faces the detection terminal 20.

In the present embodiment, the lock arm 50 particularly includes the low-rigidity portion 52 that specifically is positioned closer to the proximal end side than the pressing portion 51, and/or the pressing portion 51 is provided with the at least one rib 56.

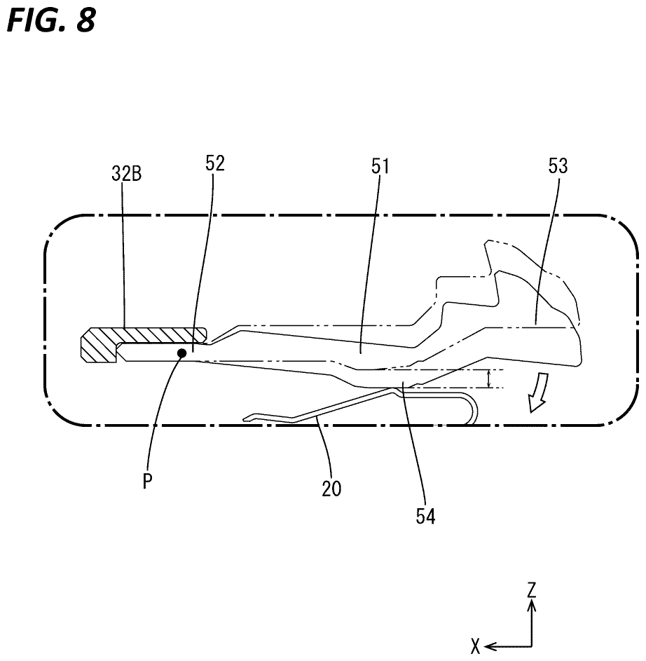

Accordingly, as shown in FIG. 8, the lock arm 50 particularly is warped by the pressing force from the lever 40 with the proximal end side that is the low-rigidity portion 52 side as a start point P.

Moreover, because the rib 56 joins the pressing portion 51 and the pressed portion 53, the lock arm 50 particularly is not easily bent on the pressed portion 53 side, and/or the pressing force from the lever 40 can be easily transmitted to the low-rigidity portion 52 side.

In other words, a part of the lock arm 50 between the pressed portion 53 that receives the pressing force from the lever 40 and the start point P particularly is not easily bent in an upward convex shape, and/or the amount of downward displacement of the protruding part 54 particularly can be made great.

When the lever 40 is further displaced (particularly rotated or pivoted), the lever-type connector 10 and the counterpart connector 80 are further engaged with each other, and the lever 40 reaches the engagement completion position.

As shown in FIG. 9, when the lever 40 substantially reaches the engagement completion position, the one or more second pressing parts 45 particularly cease to be in contact with the upper surface(s) of the engaging lock part(s) 55, and contact between the lever 40 and the lock arm 50 particularly is released. The lock arm 50 thus particularly returns towards or to the natural state.

Moreover, when the one or more second pressing parts 45 particularly move over the engaging lock part(s) 55, the second pressing part(s) 45 and the engaging lock part(s) 55 are disposed in a manner capable of being locked.

Accordingly, displacement (particularly rotation or pivotal movement) of the lever 40 from the engagement completion position to the engagement start position is prevented by the one or more engaging lock parts 55.

Furthermore, when warpage of the lock arm 50 is cancelled, the one or more contact parts 23 of the detection terminal 20 particularly elastically or resiliently return toward an initial position and/or particularly substantially come into contact with the counterpart detection terminal 83.

The detection circuit particularly is thus formed by the detection terminal 20 and the counterpart detection terminal 83, and/or completion of engagement between the counterpart connector 80 and the lever-type connector 10 can be perceived through conduction between the terminals.

Additionally, the lever-type connector 10 particularly can also detect an engagement state through a pressing operation on the detection member 60 positioned on a rear side of the housing 30.

In the case where the lock arm 50 is returned towards or to a natural position inside the housing 30, the main body part 61 of the detection member 60 particularly is pressed, and the one or more arm parts 62 particularly at least partly are inserted between the lock arm 50 and the detection terminal 20.

The detection member 60 is thus allowed to move from a standby position to a detection position.

By contrast, in the case where warpage of the lock arm 50 at least partly is maintained inside the housing 30, the one or more arm parts 62 particularly interfere with the pressed portion 53.

Accordingly, the detection member 60 particularly does not move from the standby position to the detection position.

### Operational Effects of Embodiment

(1) With the lever-type connector 10 according to the present embodiment described above, when the lever 40 is displaced (particularly rotated or pivoted) from the engagement start position toward the engagement completion position, the start point of warping of the lock arm 50 comes closer to the proximal end particularly due to the low-rigidity portion 52 provided on the lock arm 50, and the amount of downward or inward displacement of the protruding part 54 can be sufficiently secured.

Accordingly, at the time of the lever-type connector 10 engaging with the counterpart connector 80, the detection terminal 20 and the counterpart detection terminal 83 particularly can be appropriately separated by the lock arm 50, and/or wear and deformation of the detection terminal 20 particularly can be prevented.
(2) The pressing portion 51 particularly is provided with the at least one rib 56 that substantially extends in the extending direction of the lock arm 50, and thus has a higher rigidity than the low-rigidity portion 52.

Accordingly, appearance defects such as sink marks particularly can be reduced compared to a case where the thickness of the pressing portion 51 is made greater than that of the low-rigidity portion 52 all along the left-right direction.
(3) Because the low-rigidity portion 52 of the lock arm 50 particularly at least partly is covered by the upper or outer cover part 32B of the cover member 32, the low-rigidity portion 52 can be prevented from being damaged due to impact from outside.
(4) Because the chamfered part 57 particularly is formed at (particularly an end of) the rib 56 on the low-rigidity portion 52 side, the rib 56 can be prevented from interfering with the cover member 32 and the counterpart housing 81 when the lock arm 50 is warped by the pressing force from the lever 40.

Accordingly, the lock arm 50 can be prevented from not being able to easily warp on the low-rigidity portion 52 side.
(5) Because the pressing portion 51 and the pressed portion 53 particularly are joined by the at least one rib 56, the lock arm 50 particularly is not easily bent on the pressed portion 53 side, and/or the pressing force from the lever 40 can be easily transmitted to the low-rigidity portion 52 side.

Accordingly, the lock arm 50 particularly can be easily warped with the low-rigidity portion 52 side as the start point.

Accordingly, there is provided a lever-type connector that can suppress wear and deformation of a detection terminal at a time of engaging with a counterpart connector. A housing 30 of a lever-type connector 10 particularly includes a lock arm 50 that extends in a cantilever manner and that is capable of warping toward a detection terminal 20, a lever 40 includes a lever-side pressing part 43 that warps the lock arm 50 (as an exemplary warping piece) toward the detection terminal 20 during a process of displacement (particularly rotation or pivotal movement) from an engagement start position towards or to an engagement completion position, and the lock arm 50 includes at least one pressing portion 51 including at least one protruding part 54 that presses the detection terminal 20 through warping and separates the detection terminal 20 away from a counterpart detection terminal 83, and at least one low-rigidity portion 52 that is positioned closer to a proximal end side of lock arm 50 than the pressing portion 51 and that has a lower rigidity than the pressing portion 51.

### Other Embodiments

The present embodiment may be modified in the following manner. The embodiment described above and the following example changes can be combined to the extent that no technical conflict exists.
In the embodiment described above, the lock arm 50 particularly includes, on the pressing portion 51, the one or more ribs 56 that substantially extend in the front-back direction. Instead, the pressing portion 51 may include one or more ribs that intersect with each other in a net shape.
In the embodiment described above, the rib 56 of the lock arm 50 particularly joins the pressing portion 51 and the pressed portion 53. However, the rib 56 of the pressing portion 51 does not have to join the pressed portion 53.
In the embodiment described above, the rib 56 particularly is provided on the pressing portion 51 of the lock arm 50 to make the rigidity different between the pressing portion 51 and the low-rigidity portion 52. Instead, a part of the low-rigidity portion 52 of the lock arm 50 may be thinned to achieve a lower rigidity than the pressing portion 51. In this case, the pressing portion 51 particularly does not have to include the rib(s) 56.
In the embodiment described above, the housing 30 particularly includes the cover member 32. However, the housing 30 does not have to include the cover member 32. In this case, the low-rigidity portion 52 of the lock arm 50 may, but does not have to, be at least partly covered by a member different from the cover member 32.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever-type connector capable of being engaged with a counterpart connector including at least one counterpart detection terminal, the lever-type connector comprising:
a housing;
a lever that is attached to the housing in a manner capable of displacement between an engagement start position and an engagement completion position; and
at least one detection terminal that is held inside the housing, and that forms a detection circuit by coming into contact with the counterpart detection terminal, wherein the housing includes at least one warping piece that substantially extends in a cantilever manner and that is capable of warping toward the detection terminal,
the lever includes at least one lever-side pressing part that applies a pressing force for warping the warping piece toward the detection terminal during a process of displacement from the engagement start position to the engagement completion position, and
the warping piece includes
at least one pressing portion including at least one protruding part that presses the detection terminal and separates the detection terminal away from the counterpart detection terminal, and
a low-rigidity portion that is positioned closer to a proximal end side of the warping piece than the pressing portion, and that has a lower rigidity than the pressing portion.

2. The lever-type connector according to claim 1, wherein the warping piece is made of resin.

3. The lever-type connector according to claim 1, wherein the pressing portion includes at least one rib that substantially extends in an extending direction of the warping piece.

4. The lever-type connector according to claim 1, wherein the housing includes a cover member that is provided at or near a front end that engages with the counterpart connector.

5. The lever-type connector according to claim 4, wherein the warping piece substantially extends rearward from a front end side of the housing, and
the low-rigidity portion at least partly is covered by the cover member.

6. The lever-type connector according to claim 1, wherein
the pressing portion includes at least one rib that substantially extends in an extending direction of the warping piece, and
an end of the rib close to the low-rigidity portion is chamfered.

7. The lever-type connector according to claim 3, wherein the warping piece includes, at a part closer to a distal end than the pressing portion, at least one pressed portion for receiving a pressing force from the lever-side pressing part.

8. The lever-type connector according to claim 7, wherein the rib joins the pressing portion and the pressed portion.

9. The lever-type connector according to claim 1, wherein when the lock arm warps, the protruding part presses the detection terminal, and the detection terminal can be resiliently deformed.

10. A connector assembly comprising the lever-type connector according to claim 1 and a counterpart connector engageable therewith.
